(19) United States
(12) Patent Application Publication
(10) Pub. No.: US 2002/0189417 A1
(43) Pub. Date: Dec. 19, 2002

(54) Table saw

(76) Inventors: Juei-Seng Liao, Taichung City (TW); Pei-Seng Liao, Taichung City (TW)

Correspondence Address: CHRISTIE, PARKER & HALE, LLP, 350 WEST COLORADO BOULEVARD, SUITE 500, PASADENA, CA, 91105, US

(21) Appl. No.: 09/925,346

(22) Filed: Aug. 8, 2001

(30) Foreign Application Priority Data
Jun. 15, 2001 (TW) 090210112

(51) Int. Cl. B26D 7/06; B26D 1/18

(52) U.S. Cl. 83/477.2; 83/477.1; 83/99; 83/67

(57) ABSTRACT

A table saw has a height adjustable blade which is mounted in a mounting frame and which is rotatable with a blade shaft driven by an output shaft of a motor. A shaving collecting member is disposed in the vicinity of the blade to collect wood shavings. A blowing member has a casing secured to a height adjusting member and communicated with the shaving collecting member, and an impeller disposed to draw wood shavings from the shaving collecting member to the casing and out of a discharge port in the casing.

### CROSS-REFERENCE TO RELATED APPLICATION

This application claims priority of Taiwan patent Application No. 090210112, filed on Jun. 15,2001.

### BACKGROUND OF THE INVENTION

1. Field of the Invention

This invention relates to a table saw, more particularly to a table saw with a height adjustable blade, and a shaving collecting mechanism which is driven by a blade shaft of the blade.

2. Description of the Related Art

Referring to FIGS. 1 to 4, a table saw 10, disclosed in co-pending U.S. patent application Ser. No. 09/369,070, filed on Aug. 5, 1999, is shown to include a mounting frame 11 with a working table 12 and a mounting plate 13. A motor 17 is mounted on the mounting frame 11, and has an output shaft 171 with a drive pulley 172 secured thereon to deliver a driving force to a driven pulley 181 of a blade shaft 18 via a belt 173. A right end 183 of the blade shaft 18 passes through a blade height adjusting member 15 and a driven unit 16, and drives rotation of a blade 19. The driven unit 16 includes two driven blocks 161,162 which are slidably mounted in an arcuate slot 1311 formed in the mounting plate 13, and a connecting plate 163 with a bearing seat 164 which is clamped in two semi-circular notches 1611,1621 in the driven blocks 161,162 and which is rotatably connected to the right end 183 of the blade shaft 18. An actuator member 14 has an actuating end 142 with a pinion 141 which meshes with a tooth segment of a driven portion 152 of the adjusting member 15 such that when the actuator member 14 is operated to rotate, the adjusting member 15 is moved to drive the driven blocks 161,162 to slide along the slot 1311, and thus the blade shaft 18 and the blade 19 are moved toward and away from the working table 12. The actuator member 14 further has an externally operated end 144 which is disposed outwardly of a front side 111 of the mounting frame 11 and which is connected to a hand wheel 143 so as to be rotated externally to rotate the actuating end 142. Moreover, a guide rod 133 and an elongated opening 1312 extend along lines parallel to a direction on two sides of the slot 1311. A guide pin 153 is secured on the adjusting member 15, and extends into the opening 1312 to facilitate stable movement of the adjusting member 15 relative to the mounting plate 13. Since a large amount of wood shavings are formed during saw operation of the table saw 10, collecting means is needed to collect the wood shavings.

### SUMMARY OF THE INVENTION

The object of the present invention is to provide a table saw which has a shaving collecting mechanism to collect wood shavings during operation.

According to this invention, the table saw includes a mounting frame with a working table and an elongated slot which is formed in the working table and which extends in a longitudinal direction. A motor has an output shaft to deliver a driving force, and is secured to the mounting frame. The output shaft defines a first axis and extends in a first direction transverse to the longitudinal direction. A blade shaft defines a second axis parallel to the first axis, and is turnable about the first axis between first and second positions respectively proximate and distal to the working table. The blade shaft includes right and left ends which are disposed opposite to each other in the first direction, and a middle portion which is disposed between the right and left ends. A blade is mounted on the right end of the blade shaft so as to be rotated therewith about the second axis, and is extendable into the elongated slot in a second direction transverse to both the first and longitudinal directions. A drive transmission member is disposed to transmit the driving force of the output shaft of the motor to the middle portion of the blade shaft in either one of the first and second positions so as to drive the blade shaft to rotate the blade when the motor is actuated. A height adjusting member includes a driven portion which is disposed to be displaceable relative to the mounting frame in the second direction between higher and lower positions corresponding to the first and second positions respectively, and a shifting portion which is disposed to surround the middle portion of the blade shaft to move the middle portion to turn between the first and second positions. An actuator member has an actuating end which is disposed to move the driven portion to displace between the higher and lower positions, and an externally operated end which is disposed outwardly of the mounting frame so as to be operated externally to actuate movement of the actuating end. A shaving collecting member is disposed in the vicinity of the blade to collect wood shavings, and has an outlet port. An elongated hollow member defines a duct therethrough, and has a first tubular end which is connected to the shaving collecting member such that the duct is communicated with the outlet port, and a second tubular end. A blowing member includes a casing and an impeller. The casing is secured to the height adjusting member, and has proximate and distal walls which are spaced apart from each other in the first direction and respectively proximate and distal to the right end of the blade shaft to confine an accommodating chamber, and a discharge port which is disposed between the proximate and distal walls and which extends radial to the second axis. The proximate wall is mounted on the left end of the blade shaft to permit rotation of the left end relative thereto. The distal wall is provided with an inlet port which is connected to and which is communicated with the second tubular end of the hollow member. The impeller is received in the accommodating chamber, and is mounted to be driven by the left end of the blade shaft to rotate about the second axis so as to draw wood shavings from the shaving collecting member to the accommodating chamber via the duct and out of the discharge port.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a table saw disclosed in co-pending U.S. patent application Ser. No. 09/369,070;

FIG. 2 is a fragmentary exploded view showing a portion of the table saw in FIG. 1;

FIGS. 3 and 4 are fragmentary perspective and sectional views showing the portion of the table saw in FIG. 1, respectively;

FIG. 5 is a perspective view of a preferred embodiment of a table saw according to this invention when a working table is turned;

FIG. 6 is a perspective view similar to FIG. 5 but viewed from another angle;

FIG. 7 is a fragmentary exploded perspective view showing a portion of the preferred embodiment of this invention;

FIG. 8 is a schematic view illustrating how wood shavings drop into a shaving collecting member of the preferred embodiment; and

FIG. 9 is a sectional view illustrating how wood shavings are drawn out of a blowing member of the preferred embodiment.

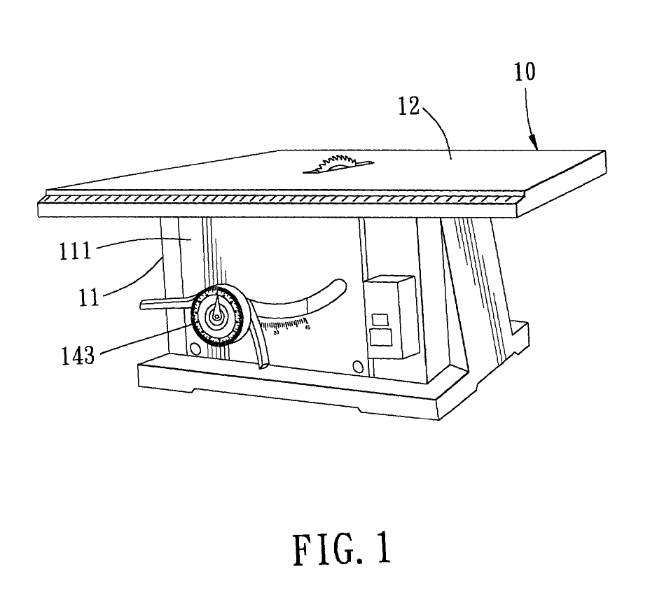

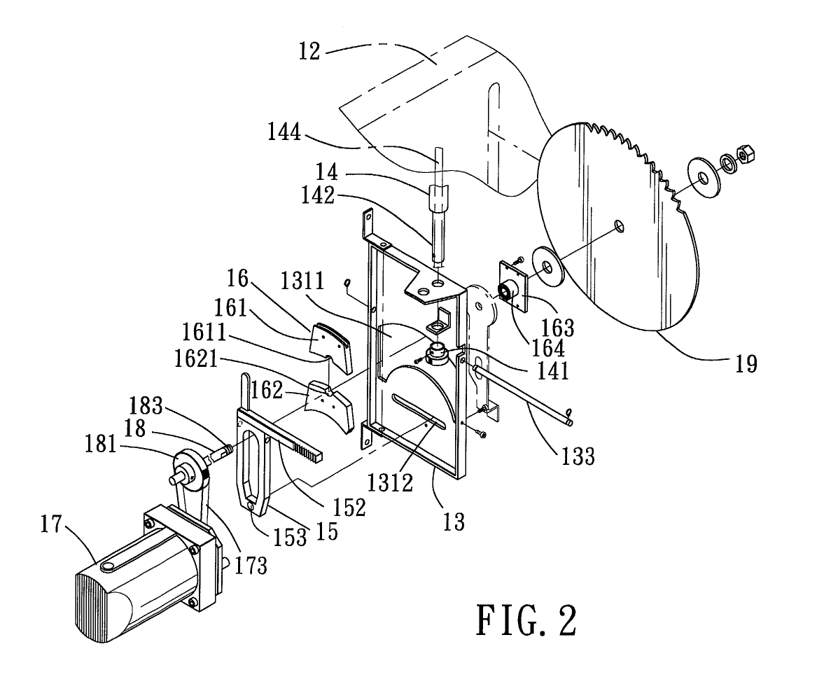

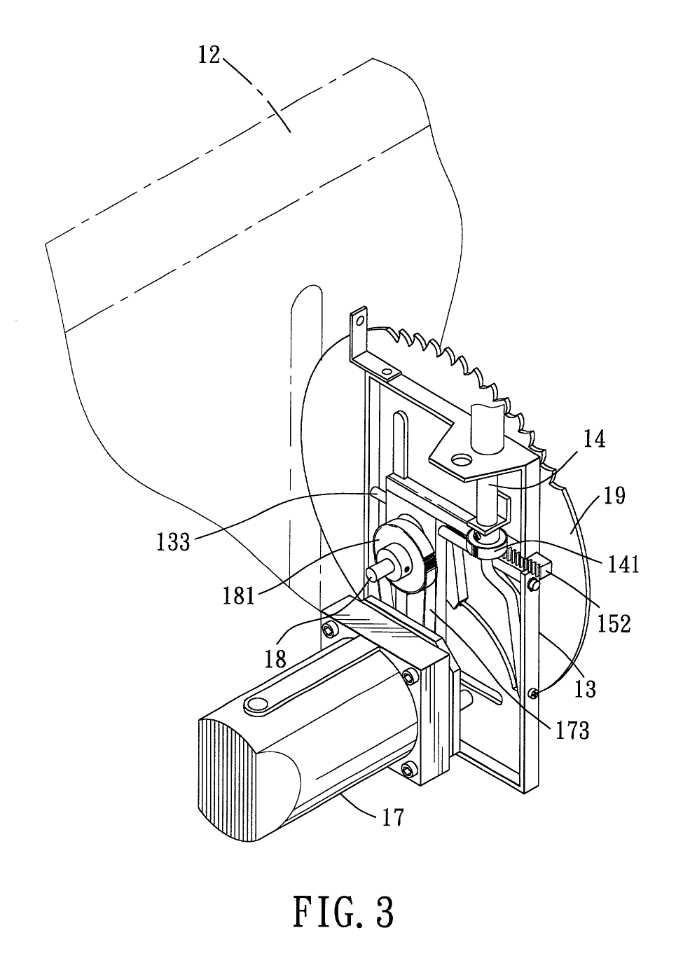

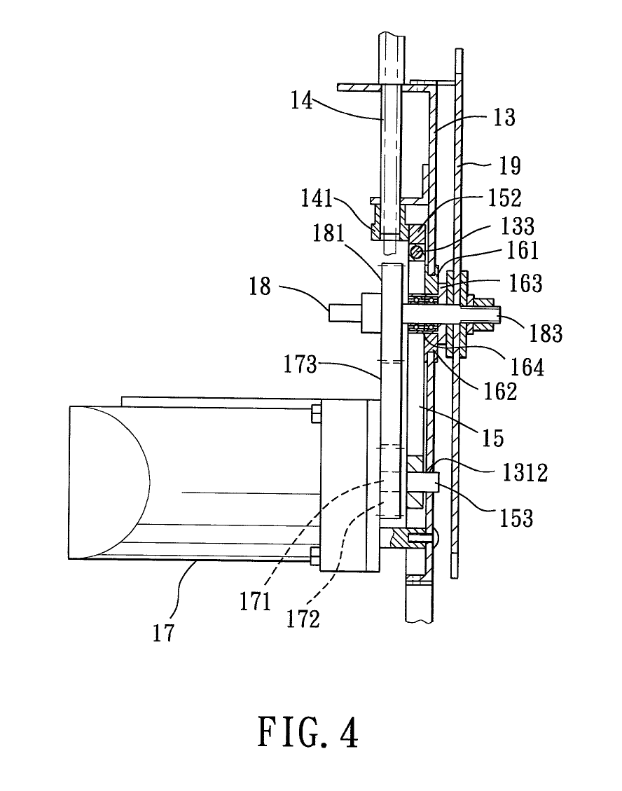

### DETAILED DESCRIPTION OF THE PREFERRED EMBODIMENT

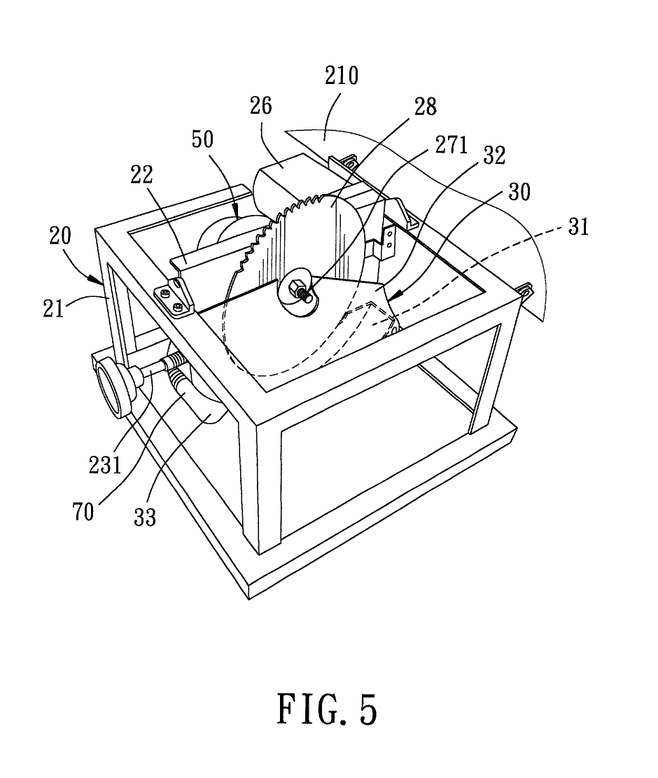

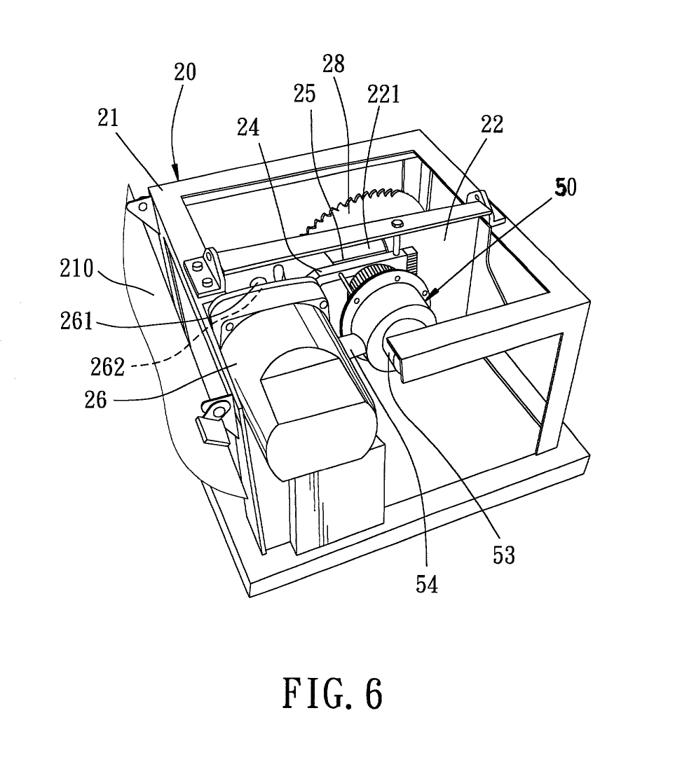

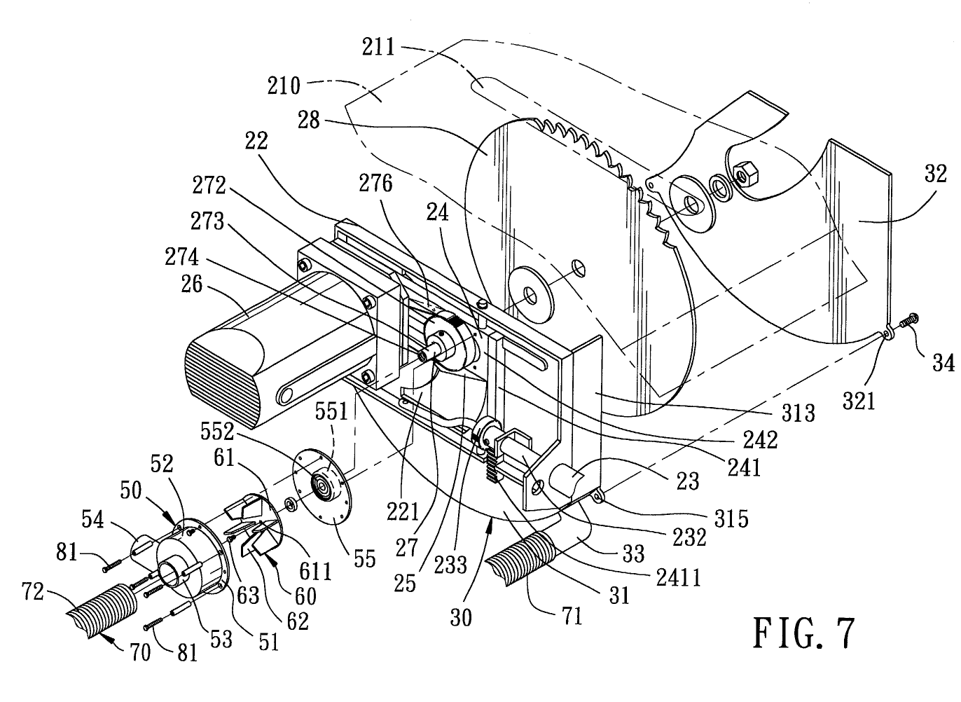

Referring to FIGS. 5, 6 and 7, the preferred embodiment of the table saw 20 according to the present invention is shown to comprise a mounting frame 21 which has a working table 210, and an elongated slot 211 that is formed in the working table 210 and that extends in a longitudinal direction.

A motor 26 has an output shaft 261 to deliver a driving force, and is secured to a mounting seat 22 of the mounting frame 21. The output shaft 261 defines a first axis and extends in a first direction transverse to the longitudinal direction.

A blade shaft 27 defines a second axis parallel to the first axis, and is turnable about the first axis between first and second positions respectively proximate and distal to the working table 210. The blade shaft 27 includes right and left ends 271, 273 which are disposed opposite to each other in the first direction, and a middle portion 275 which is disposed between the right and left ends 271,273.

A blade 28 is mounted on the right end 271 of the blade shaft 27 so as to be rotated therewith about the second axis, and is extendable into the elongated slot 211 in a second direction transverse to both the first and longitudinal directions.

A drive transmission member includes a drive pulley 262 which is mounted on and rotated with the output shaft 261 of the motor 26, a driven pulley 272 which is mounted on and rotated with the middle portion 275 of the blade shaft 27, and a belt 276 which is trained on the drive and driven pulleys 262,272 to transmit the driving force of the output shaft 261 to the blade shaft 27 so as to drive the blade shaft 27 to rotate the blade 28 when the motor 26 is actuated.

A blade height adjusting member 24 includes a driven portion 241 which is disposed to be displaceable relative to the mounting seat 22 in the second direction between higher and lower positions corresponding to the first and second positions respectively, and a shifting portion 242 which is disposed to surround the middle portion 275 of the blade shaft 27 to move the middle portion 275 to turn between the first and second positions in the manner described previously. Briefly, an arcuate slot 221, which acts as a guiding keyway, is formed in the mounting seat 22 and extends around the second axis. A driven block 25, which acts as a key, clamps the middle portion 275 of the blade shaft 27 at a position proximate to the right end 271, and is mounted in and is slidable relative to the slot 221 so as to turn the blade shaft 27 between the first and second positions.

An actuator member 23 is rotatable about a third axis parallel to the longitudinal direction, and has an actuating end 232 with a pinion 233 which meshes with a tooth segment 2411 of the driven portion 241 so as to move the driven portion 241 to displace between the higher and lower positions, and an externally operated end 231 which is disposed outwardly of the mounting frame 21 so as to be operated externally to actuate movement of the actuating end 232.

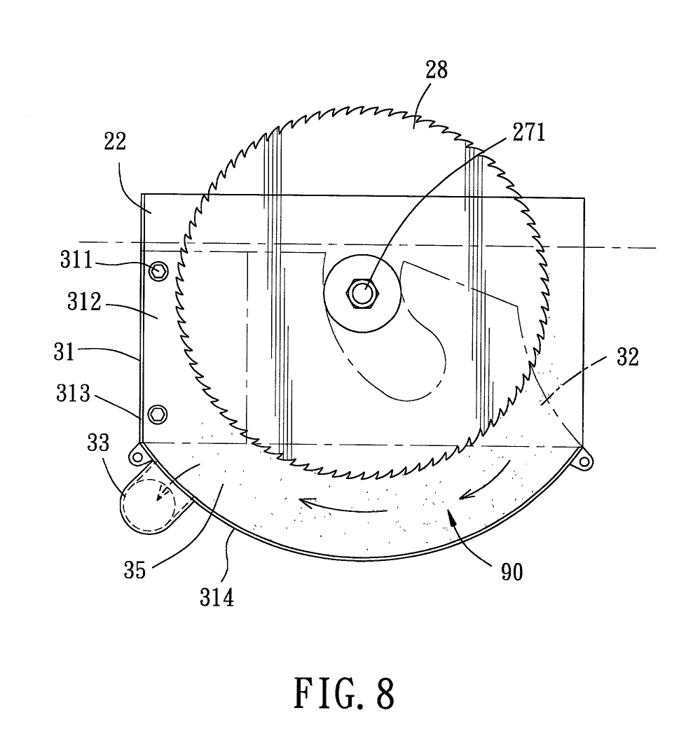

A shaving collecting member 30 is disposed in the vicinity of the blade 28 to collect wood shaving. The shaving collecting member 30 has an L-shaped inner seat 31 and an outer plate 32. With reference to FIG. 8, the inner seat 31 includes a lock plate 312 which is secured on the mounting seat 22 by means of screws 311, a side plate 313, and an arcuate bottom plate 314. The outer plate 32 is secured to the bottom plate 314 by screws 34 which pass through lock holes 321 and into screw holes 315 so as to cooperate with the inner seat 31 to confine a shaving collecting space 35 therebetween. An outlet port 33 is formed in the inner seat 31.

A flexible elongated hollow member 70 defines a duct 73 therethrough, and has a first tubular end 71 which is connected to the shaving collecting member 30 such that the duct 73 is communicated with the outlet port 33, and a second tubular end 72.

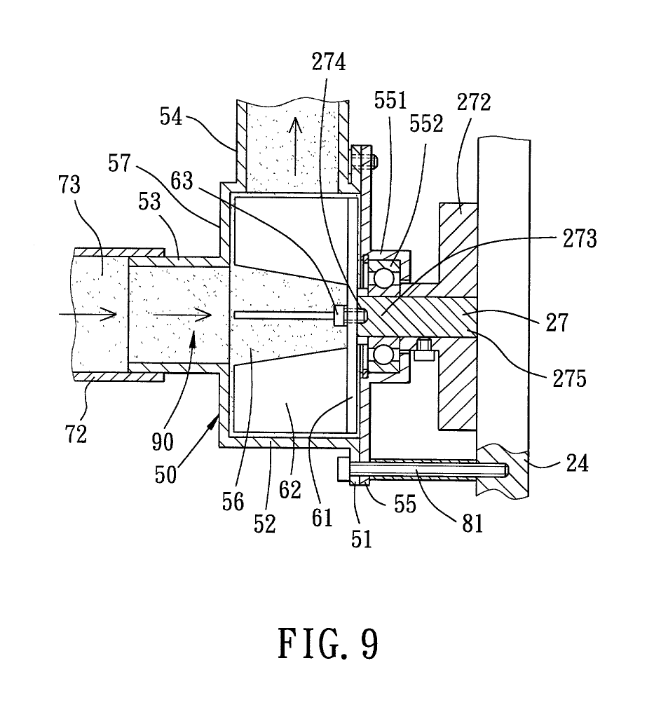

A blowing member includes a casing 50 and an impeller 60. With reference to FIG. 9, the casing 50 includes a proximate wall 51 which is secured to and which is spaced apart from the height adjusting member 24 in the first direction by means of screws 81, a distal wall 57 which is spaced apart from the proximate wall 51 in the first direction, and a surrounding wall 52 which interconnects the proximate and distal walls 51,57 to confine an accommodating chamber 56. A discharge port 54 is disposed in the surrounding wall 52 and extends radial to the second axis. A cover plate 55 is secured to the proximate wall 51 to cover the accommodating chamber 56, and has a concaved bearing seat 551 for receiving a bearing 552. Thus, the left end 273 of the blade shaft 27 is mounted rotatably in the accommodating chamber 56. Moreover, the distal wall 57 is provided with an inlet port 53 which is connected to and which is communicated with the second tubular end 72 of the hollow member 70.

The impeller 60 is received in the accommodating chamber 56, and includes a connecting plate 61 which is secured on the left end 273 of the blade shaft 27 by a screw 63 that passes through a hole 611 and engages threadedly a screw hole 274 in the left end 273 so as to be driven by the left end 273 to rotate a plurality of fins 62 on the connecting plate 61 about the second axis. Thus, as shown in FIGS. 8 and 9, when the motor 26 is actuated for saw operation, wood shavings 90 can be collected by the shaving collecting member 30, and can then be drawn from the shaving collecting member 30 to the accommodating chamber 56 via the duct 73 and out of the discharge port 54.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. A table saw comprising:
a mounting frame having a working table and an elongated slot which is formed in said working table and which extends in a longitudinal direction;
a motor having an output shaft to deliver a driving force, said motor being secured to said mounting frame, said output shaft defining a first axis and extending in a first direction transverse to the longitudinal direction;
a blade shaft defining a second axis parallel to the first axis, and turnable about the first axis between first and second positions respectively proximate and distal to said working table, said blade shaft including right and left ends which are disposed opposite to each other in the first direction, and a middle portion which is disposed between said right and left ends;
a blade mounted on said right end of said blade shaft so as to be rotated therewith about the second axis, and extendable into said elongated slot in a second direction transverse to both the first and longitudinal directions;
a drive transmission member disposed to transmit the driving force of said output shaft of said motor to said middle portion of said blade shaft in either one of the first and second positions so as to drive said blade shaft to rotate said blade when said motor is actuated;
a height adjusting member including a driven portion disposed to be displaceable relative to said mounting frame in the second direction between higher and lower positions corresponding to the first and second positions respectively, and a shifting portion disposed to surround said middle portion of said blade shaft to move said middle portion to turn between the first and second positions;
an actuator member having an actuating end disposed to move said driven portion to displace between the higher and lower positions, and an externally operated end disposed outwardly of said mounting frame so as to be operated externally to actuate movement of said actuating end;
a shaving collecting member disposed in the vicinity of said blade to collect wood shavings, said shaving collecting member having an outlet port;
an elongated hollow member defining a duct therethrough, and having a first tubular end connected to said shaving collecting member such that said duct is communicated with said outlet port, and a second tubular end; and
a blowing member including
a casing secured to said height adjusting member, and having proximate and distal walls which are spaced apart from each other in the first direction and respectively proximate and distal to said right end of said blade shaft to confine an accommodating chamber, and a discharge port which is disposed between said proximate and distal walls and which extends radial to the second axis, said proximate wall being mounted on said left end of said blade shaft to permit rotation of said left end relative thereto, said distal wall being provided with an inlet port which is connected to and which is communicated with said second tubular end of said hollow member, and
an impeller received in said accommodating chamber, and mounted to be driven by said left end of said blade shaft to rotate about the second axis so as to draw wood shavings from said shaving collecting member to said accommodating chamber via said duct and out of said discharge port.

2. The table saw of claim 1, wherein said drive transmission member includes a drive pulley mounted to rotate with said output shaft, a driven pulley mounted to rotate with said middle portion of said blade shaft, and a belt trained on said drive and driven pulleys to transmit the driving force of said output shaft to said blade shaft.

3. The table saw of claim 1, wherein said mounting frame has an arcuate guiding keyway extending around the second axis, said height adjusting member further including a key mounted in and slidable relative to said keyway, said middle portion of said blade shaft being mounted on and passing through said key at a position proximate to said right end so as to be turned between the first and second positions when said key is moved along said keyway.

4. The table saw of claim 3, wherein said actuating member is rotatable about a third axis parallel to the longitudinal direction, said driven portion of said height adjusting member having a tooth segment which extends in the second direction, said actuating end of said actuator member being provided with a pinion which meshes with said tooth segment so as to move said driven portion in the second direction between the higher and lower positions.

5. The table saw of claim 1, wherein said elongated hollow member is made of a flexible material.
